(19) United States
(12) Patent Application Publication
(10) Pub. No.: US 2012/0256065 A1
(43) Pub. Date: Oct. 11, 2012

(54) PORTABLE PANEL FOR ADDING UTILITY TO A FENCING MATERIAL

(76) Inventor: ROBERT H. NORDSELL, Euless, TX (US)

(21) Appl. No.: 13/081,428

(22) Filed: Apr. 6, 2011

(51) Int. Cl. F16M 13/02

(52) U.S. Cl. 248/221.11

(57) ABSTRACT

The teachings provided herein are generally directed to a portable, utility panel for adding a utility to a fencing material. The panel comprises a vertical base panel including a front surface having a utility and a back surface, the back surface positioned parallel, or substantially parallel, to a fencing material during a use of the utility panel. The panel can have tool-free fasteners attached to the vertical base panel for releasably connecting the vertical base panel to the fencing material in a fixed, or substantially fixed, position relative to an x, y, and z-direction.

### BACKGROUND

1. Field of the Invention

The teachings provided herein are generally directed to a portable, utility panel for adding a utility to a fencing material.

2. Description of Related Art

A fence is a freestanding structure designed to restrict or prevent movement across a boundary. Fences are constructed for several purposes, including the enclosure of industrial, residential, or public areas. Regardless, fences have become an abundant part of the infrastructure of just about any human society.

Surprisingly, unlike traditional “walls,” fencing materials typically lack in the availability of accessories that increase their usefulness. As fences are such an integral part of our infrastructure, we find ourselves near fences on a regular basis. This can occur, for example, in public sporting venues or perhaps around the house and garden. Many such fencing structures have openings within which people have regularly tried to hang or fasten attachments in some way to increase the usefulness of the fence, often in a make-shift manner. In fact, we've become accustomed to the lack of utility of such materials and accept them basically for what they are—merely an obstruction to our movements rather than an otherwise useful support for other uses.

A portable attachment for such fencing structures that increases the usefulness of a fence in a variety of venues and locations would be appreciated.

### SUMMARY

The teachings provided herein are generally directed to a portable, utility panel for adding a utility to a fencing material. In some embodiments, the panel comprises a vertical base panel including a front surface having a utility and a back surface, the back surface positioned parallel, or substantially parallel, to a fencing material during a use of the utility panel. The panel can have tool-free fasteners attached to the vertical base panel for releasably connecting the vertical base panel to the fencing material in a fixed, or substantially fixed, position relative to an x, y, and z-direction.

It should be appreciated that the x and y directions can be on a plane formed by the vertical base panel and, as such, can be parallel, or substantially parallel, to a plane formed by the fencing material. Likewise, the z direction can be normal, or substantially normal, to the plane formed by the fencing material. In some embodiments, there may be no, or substantially no, translational movement of the vertical base relative to the fencing material during the use of the utility panel, the translational movement including movement in the x and y directions.

One of skill will appreciate that the fencing material can include nearly any configuration known in the art. In some embodiments, the fencing material can be a fencing fabric comprising chain-link fencing material.

One of skill will appreciate that the panel can have fasteners that require tools, or the fasteners can be tool-free. For example, the tool-free fasteners can be positioned, or positionable, as a plurality of prongs or cleats that are configured to insert in an opening in the fencing fabric. In some embodiments, the fasteners can be inserted under tension to form a releasably connectable friction fitting between the fasteners and the fencing fabric. In some embodiments, the tool-free fasteners can be positioned, or positionable, as a plurality prongs configured to insert in an opening in the fencing fabric under tension to form a releasably connectable friction fitting between the fasteners and the fencing fabric, the releasably connectable friction fitting including a hook on a prong in the plurality of prongs to complement a fencing fabric configuration and to inhibit movement of the vertical base panel in the z-direction. In some embodiments, the tool-free fasteners can be positioned, or positionable, as a plurality prongs configured to insert in an opening in the fencing fabric under tension to form a releasably connectable friction fitting between the fasteners and the fencing fabric, the releasably connectable friction fitting including a ratcheting mechanism to inhibit movement in the z-direction. One of skill will appreciate that, in some embodiments, the tool-free fasteners can include nearly any means for fastening the vertical base panel to a chain link fence.

In some embodiments, the fencing can be used to contain, enclose, or support all or some of a sporting activity. For example, the panel can be a portable, coaching-utility panel for adding a coaching-utility to a fencing material. In some embodiments, the panel includes a front surface having a coaching-utility and a back surface, the back surface positioned parallel, or substantially parallel, to a fencing material during a use of the coaching-utility panel. For example, the coaching utility can include a plurality of uses, such as (i) hangers for sporting equipment and (ii) a surface for displaying written materials. It should be appreciated that any use or combination of uses for coaching or playing a sport can be identified as a utility for the panel.

In some embodiments, the fencing can be used to contain, enclose, or support all or some of a yard or park activity. Gardening or groundskeeping can be considered examples of such activities. For example, the panel can be a portable, gardening-utility panel for adding a gardening-utility to a fencing material. In some embodiments, the panel includes a front surface having a gardening-utility and a back surface, the back surface positioned parallel, or substantially parallel, to a fencing material during a use of the gardening-utility panel. For example, the gardening utility can include a plurality of uses, such as (i) hangers for gardening equipment and (ii) a surface for displaying a plant.

### BRIEF DESCRIPTION OF THE DRAWINGS

FIGS. 1A and 1B illustrate a coaching utility panel, according to some embodiments.

FIG. 2 illustrates array of sporting-utility panels attached to a chain-link fence as an advertising display, according to some embodiments.

FIG. 3 illustrates a tool-free mechanical fastener configuration with adjustable cleats for attaching a utility panel to a fencing fabric, according to some embodiments.

FIGS. 4A and 4B illustrate additional tool-free mechanical fastener configurations for attaching a utility panel to a fencing fabric, according to some embodiments.

FIGS. 5A-5C illustrate clip fasteners for attaching a utility panel to a fence fabric, according to some embodiments.

### DETAILED DESCRIPTION

The teachings provided herein are generally directed to a portable, utility panel for adding a utility to a fencing material.

In some embodiments, the panel comprises a vertical base panel including a front surface having a utility and a back surface, the back surface positioned parallel, or substantially parallel, to a fencing material during a use of the utility panel. The panel can have tool-free fasteners attached to the vertical base panel for releasably connecting the vertical base panel to the fencing material in a fixed, or substantially fixed, position relative to an x, y, and z-direction.

It should be appreciated that the x and y directions can be on a plane formed by the vertical base panel and, as such, can be parallel, or substantially parallel, to a plane formed by the fencing material. Likewise, the z direction can be normal, or substantially normal, to the plane formed by the fencing material. In some embodiments, there may be no, or substantially no, translational movement of the vertical base relative to the fencing material during the use of the utility panel, the translational movement including movement in the x and y directions.

The term “substantial” can be used to refer to a relative change that does not detrimentally affect the intended use of the panel. Changes can include, for example, a deviation from a parallel position or an amount of a movement of the panel during use. For example, in some embodiments, a change can be either 0, 1, 2, 3, 4, 5, 10, 15, 20, 25, 30, 35, 40, 45, 50, 55, 60, 65, 70, 75, or even 80 percent from the intended use, and the use is not detrimentally affected. In some embodiments, the change should be 25% or less, 20% or less, 15% or less, 10% or less, or 5% or less. In some embodiments, the change should be 3% or less, 2% or less, or 1% or less.

One of skill will appreciate that the fencing material can include nearly any configuration or fabric known in the art. In some embodiments, the fencing material can be a fencing fabric comprising chain-link fencing material.

One of skill will appreciate that the panel can have fasteners that require tools, or the fasteners can be tool-free. The term “tool-free” can be used to refer to what is needed to attach or detach the panel from a fencing material under an intended use. In some embodiments, the panel can be attached without tools using only a pair of hands. In some embodiments, the panel can be detached without tools using only a pair of hands. In some embodiments, the panel can have its own specialized “tool” included with the panel, such that the term “tool-free” may refer to a lack of a need for an extra tool. One of skill will appreciate that the term “tool” includes what one of skill would ordinarily consider to be a tool including, but not limited to, a screwdriver, a wrench, a hammer, pliers, and the like.

One of skill will appreciate that the fastener can be virtually any fastener available in the art, to the extent that the fastener will perform as intended to provide the panel in a fixed, or substantially fixed, position relative to an x, y, and z-direction. Fasteners that require tools include, but are not limited to, straps, screws, bolts, and the like. Fasteners that are “tool-free” include, but are not limited to, clips, prongs, cleats, elastomers, hooks, and adjustable variations of the same, as well as combinations thereof. In some embodiments, the tool-free fasteners can include magnets, hook-and-latch (e.g., VELCRO), adhesives, or some combination thereof. In some embodiments, the tool-free fasteners can be positioned, or positionable, as a plurality of prongs or cleats that are configured to insert in an opening in the fencing fabric. In some embodiments, the fasteners can be inserted under tension to form a releasably connectable friction fitting between the fasteners and the fencing fabric. In some embodiments, the tool-free fasteners can be positioned, or positionable, as a plurality prongs configured to insert in an opening in the fencing fabric under tension to form a releasably connectable friction fitting between the fasteners and the fencing fabric, the releasably connectable friction fitting including at least one hook on at least one prong in the plurality of prongs to complement a fencing fabric configuration, where the hook or hooks inhibit movement of the vertical base panel in at least the z-direction. In some embodiments, the tool-free fasteners can be positioned, or positionable, as a plurality prongs configured to insert in an opening in the fencing fabric under tension to form a releasably connectable friction fitting between the fasteners and the fencing fabric, the releasably connectable friction fitting including a ratcheting mechanism to inhibit movement in the z-direction. As such, one of skill will appreciate that, in some embodiments, the tool-free fasteners can include nearly any means for fastening the vertical base panel to a chain link fence.

In some embodiments, the panel has at least two utilities, such that the panel is not intended for a single use, such as to display a sign or hang a single object. Uses can include, for example; hanging, containing, or dispensing sporting equipment; serving as sporting equipment, such as a basketball backboard; hanging or containing first aid equipment; hanging a scoreboard; serving as a platform for home or garden items; hanging gardening or groundskeeping equipment; hanging or containing tools, gloves, or chemicals; displaying text or advertisements; hanging a clipboard; functioning as a chalkboard, greaseboard, or dry-erase board; functioning as a support surface for drinks or foods; functioning as a support surface for sitting; hanging ball washing equipment; hanging ball dispensing equipment; hanging garbage disposal containers; dispensing bags, gloves, and the like; dispensing chemicals or fluids; and holding or supporting a fluid or food dispenser; hanging communications equipment, such as a portable phone; hanging lighting, an LED display, cameras, speakers, or heaters; hanging electronic equipment, such as sensors or transmitters; hanging security equipment; or any combination of the above. It should be appreciated that any of the electronic equipment can be powered by any electrical source whether AC or DC including, but not limited to, battery power, solar power, or power from any source known to one of skill.

Combinations can include, for example, a hanger for sporting equipment that also includes a display for text or advertisements; a hanger for sporting equipment that includes a greaseboard, chalkboard, or clipboard hanger; a scoreboard that has lighting, an LED display, cameras or speakers; a support surface for sitting with a clipboard hanger; a support surface for sitting with a surface for holding or supporting a fluid or food; a support surface for sitting with a utility for hanging or containing tools; a support surface for displaying a plant with hangers for gardening tools; a support surface for hanging a plant with lighting; a hanger for security sensors and lighting; and any combination of at least the utilities taught herein.

The fencing that supports the panel can be commercial, public or residential. It should be appreciated that any type of fence may be useful with the teachings provided herein. An example of a useful fence includes any fence that facilitates attachment of a utility panel having the functions taught herein, such that the utility panel can be fastened with tools or without tools, as taught herein. In some embodiments, the fencing comprises a wire fencing fabric, such as a chain-link fence.

In some embodiments, the fencing can be used to contain, enclose, or support all or some of a sporting activity. For example, the panel can be a portable, coaching-utility panel for adding a coaching-utility to a fencing material. In some embodiments, the panel includes a front surface having a coaching-utility and a back surface, the back surface positioned parallel, or substantially parallel, to a fencing material during a use of the coaching-utility panel. For example, the coaching utility can include a plurality of uses, such as (i) hangers for sporting equipment and (ii) a surface for displaying written materials. It should be appreciated that any use or combination of uses for coaching or playing a sport can be identified as a utility for the panel.

In some embodiments, the fencing can be used to contain, enclose, or support all or some items of a home, yard or park activity. Gardening or groundskeeping can be considered examples of such activities. For example, the panel can be a portable, gardening-utility panel for adding a gardening-utility to a fencing material. In some embodiments, the panel includes a front surface having a gardening-utility and a back surface, the back surface positioned parallel, or substantially parallel, to a fencing material during a use of the gardening-utility panel. For example, the gardening utility can include a plurality of uses, such as (i) hangers for gardening equipment and (ii) a surface for displaying a plant.

One of skill will appreciate that the utility panel can be fabricated from any suitable material, such as plastic or metal, or a combination thereof. The utility panel can be molded as one or more pieces, assembled from a plurality of pieces, or a combination thereof. And, it should be appreciated that the utility panel can be manufactured in any size suitable for a particular purpose, where the number and type of fasteners needed for the purpose can be readily determined by one of skill.

### Example 1

### A Coaching-Utility Panel

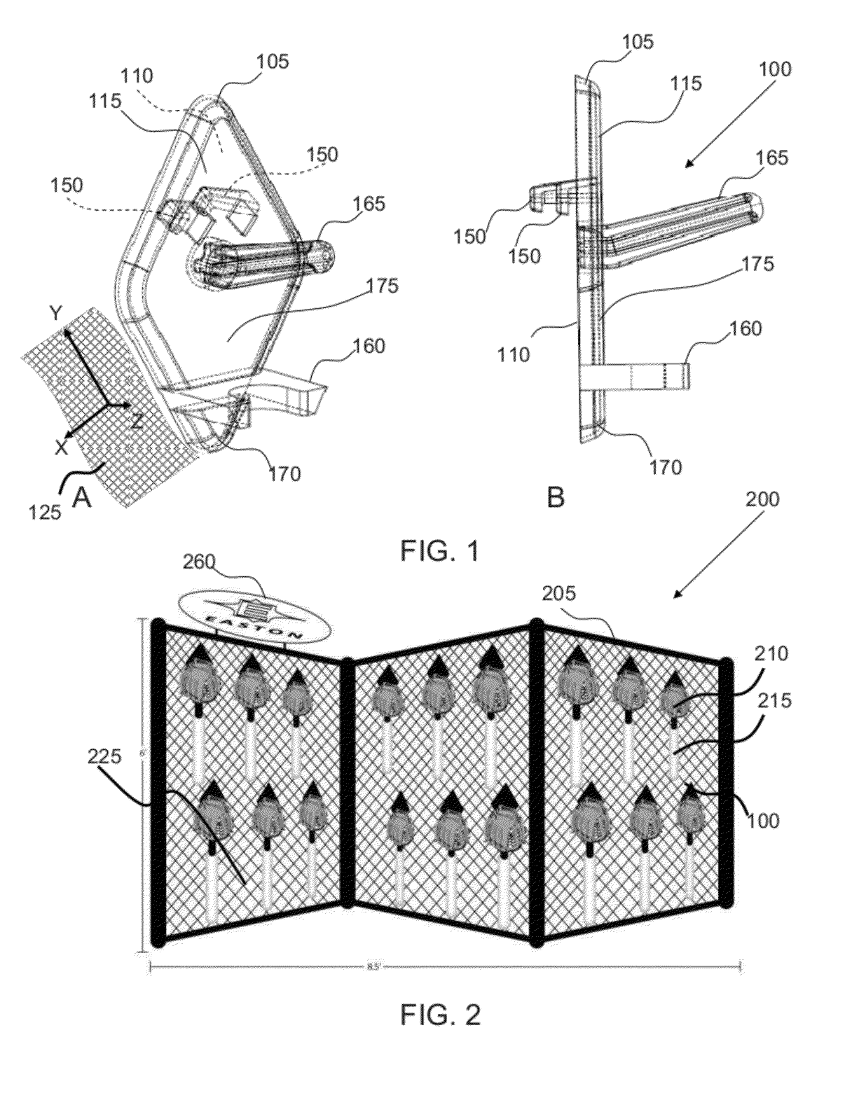

FIGS. 1A and 1B illustrate a coaching utility panel, according to some embodiments. The coaching utility panel 100 has a vertical base panel 105 that has a back surface 110 and a front surface 115. When attached to a fence, the back surface 110 is positioned parallel, or substantially parallel, to a plane 120 formed by the fencing fabric (not shown) during use of the utility panel 100. Tool-free fasteners 150 are attached to the vertical base 105 for releasably connecting the vertical base 105 to the fencing fabric (not shown) in a fixed, or substantially fixed, position relative to the x-, y-, and z-directions shown.

The tool-free fasteners 150 have two prongs 151,153, also referred to as cleats, that are offset in length to accommodate the wire wrapping configuration of a chain-link fence. This configuration of fastener successfully holds the utility panel 100 to the fencing fabric (not shown) in a fixed, or substantially fixed, position relative the x-, y-, and z-directions.

The utility panel 100 has a combination utility in that it has a hanger 160 for a baseball bat (not shown), as well as a hanger 165 for a baseball glove. An optional utility is a clip-board hanger included at position 170 and perhaps an advertisement, for a sporting goods company or a team, or both at position 175.

### Example 2

### An Array of Sporting-Utility Panels Attached to a Chain-Link Fence as an Advertising Display

FIG. 2 illustrates array of sporting-utility panels attached to a chain-link fence as an advertising display, according to some embodiments.

The coaching-utility panel of FIGS. 1A-1C can be used in a marketing display unit 200, where the coaching-utility panel 100 attached as an array of such panels to a chain link fence 205 as the display unit 200. In this example, baseball gloves 210 and bats 215 hang from each utility panel 100. The display unit 200 can be used, for example, either at a sporting event, or on an advertising display in a store, or perhaps some other portable display, such as an industry conference display. The display unit 200 can be of any practical size, where it can be manufactured on-site using any available fencing, or the fence 205 can be brought to the site. The display unit 200 can use very little space, where in this example, the fence fabric 225 is only 6 feet high and 8.5 feet long, easily hanging 18 baseball gloves and bats on the display 200 while having a marketing sign 260 for additional sales marketing functionality to the display unit 200.

It should be appreciated that the same marketing displays are often assembled, disassembled, and re-assembled at various locations within a single store, as well as at various sites. The sites can be located apart at much greater distances, such as different stores, different cities, and even different states or countries. Display units having tool-free fasteners assist greatly in the repeated assembly and disassembly of the display units.

### Example 3

### Portable Utility Panel with Adjustable Cleats

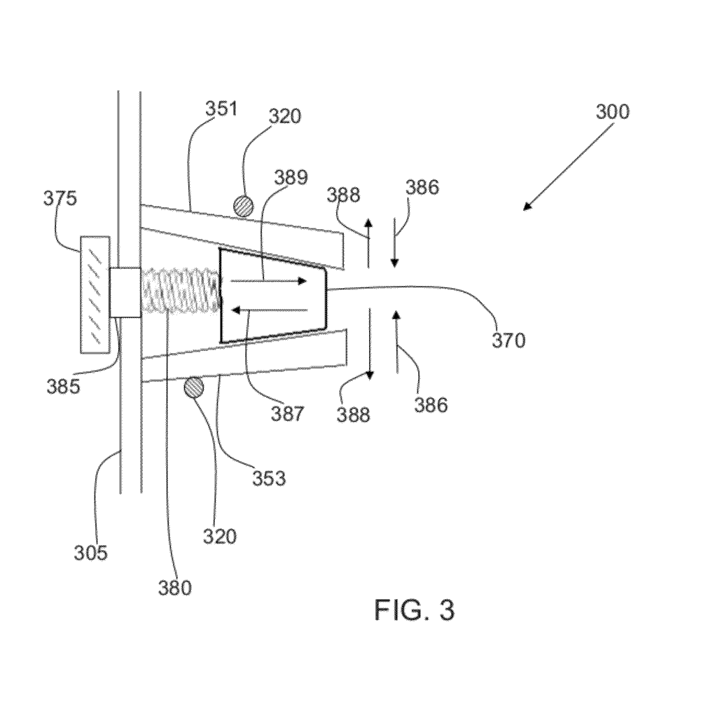

FIG. 3 illustrates a tool-free mechanical fastener configuration with adjustable cleats for attaching a utility panel to a fencing fabric, according to some embodiments.

The tool-free mechanical fastener 300 is operably attached to the vertical base panel 305 and includes a plurality of prongs or cleats 351,353 that contact fence fabric 320. A translational wedge 370 is complementary to the inner walls of cleats 351,353 and, through operation of dial 375 turning threads 380 by rotating at boss 385, wedge 370 translates in 387 to decrease pressure 386 between the cleats 351,353 and fabric 320. Likewise, turning threads 380 in the opposite direction causes the wedge 370 to translate out 389 to increase pressure 388 between the cleats 351,353 and fabric 320.

It should be appreciated that the fastener can include a dial ratcheting mechanism in the rotation of the dial 375 to assist in the operation and locking of the adjustable cleats.

### Example 4

### Portable Utility Panel with Ratcheting Adjustable Cleats

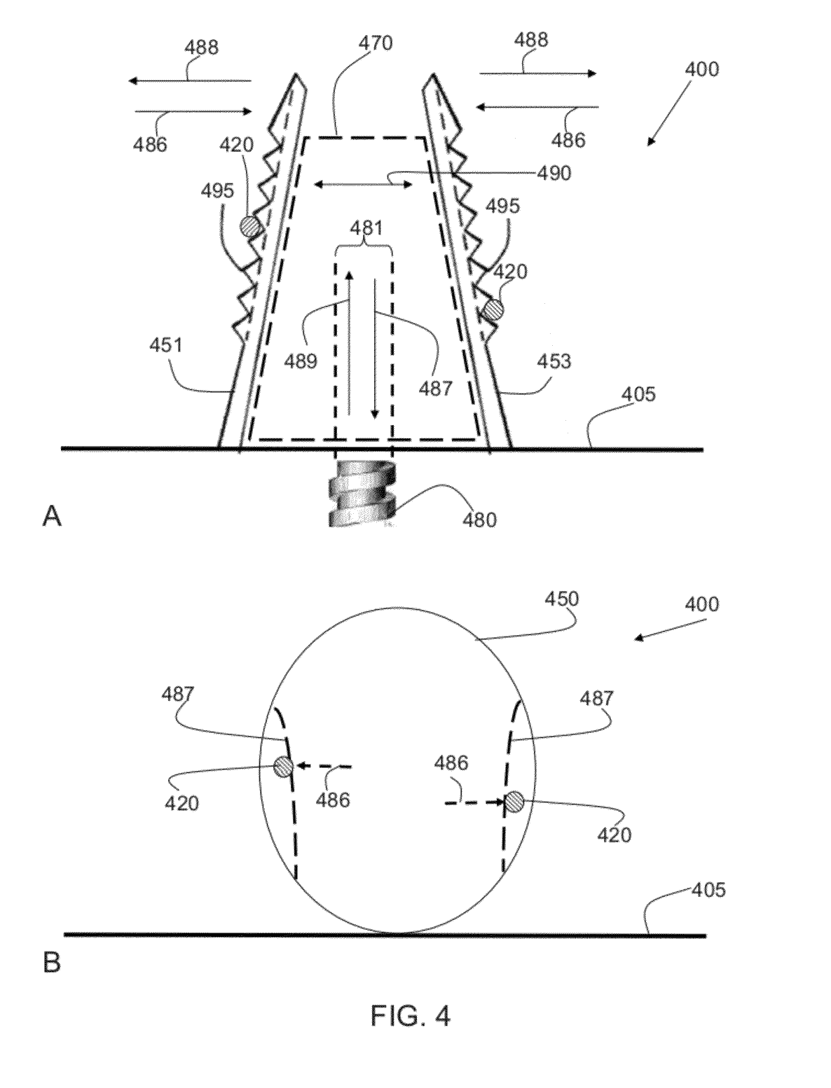

A ratcheting mechanism can be used to facilitate a locking of the cleats on the fence fabric. FIGS. 4A and 4B illustrate additional tool-free mechanical fastener configurations for attaching a utility panel to a fencing fabric, according to some embodiments.

FIG. 4A illustrates a tool-free mechanical fastener configuration with ratcheting prongs. The tool-free mechanical fastener 400 is operably attached to the vertical base panel 405 and includes a plurality of prongs or cleats 451,453 that contact fence fabric 420. A translational wedge 470 is complementary to the inner walls of cleats 451,453 and, through operation of a dial (not shown) turning threads 480, wedge 470 translates in 487 to decrease pressure 486 between the cleats 451,453 and fabric 420. Likewise, turning threads 480 in the opposite direction causes the wedge 470 to translate out 489 to increase pressure 488 between the cleats or prongs 451,453 and fabric 420.

In some embodiments, the translational wedge mechanism can be replaced or supplemented by an elastomeric wedge having elasticity 490 that allows cleats 451,453 to flex in and out and apply a releasable pressure between cleats 451,453 and fabric 420.

The system can have a ratcheting mechanism 495 on the surface of cleats 451,453 that contact fabric 420 during operation of the utility panel. The ratcheting mechanism, in the nature of a zip-tie type mechanism, zips in and out of the opening in the mesh of fabric 420. Turning threads 480 increases or decreases the pressure between the cleats 451,453 and fabric 420, and the cleats 451,453 may be locked in place for a firm non-translational positioning of the utility panel to a fence.

It should be appreciated that the fastener can include a dial ratcheting mechanism in the rotation of the dial (not shown) to assist in the operation and locking of the adjustable cleats.

FIG. 4B illustrates a tool-free fastener configuration with having an elastomeric material for attaching a utility panel to a fencing fabric, according to some embodiments.

The tool-free fastener 401 is operably attached to the vertical base panel 405 and includes an elastomeric material 450 that contact fence fabric 420. The elastomeric material 450 compresses 487 to apply pressure 486 between the elastomeric material 450 and fabric 420. The pressure 486 from the compression 487 can be adjusted through selection of elastomeric material 450 which, in any event, should be selected to provide a firm non-translational positioning of the utility panel to a fence.

### Example 5

### Portable Utility Panel with Clips

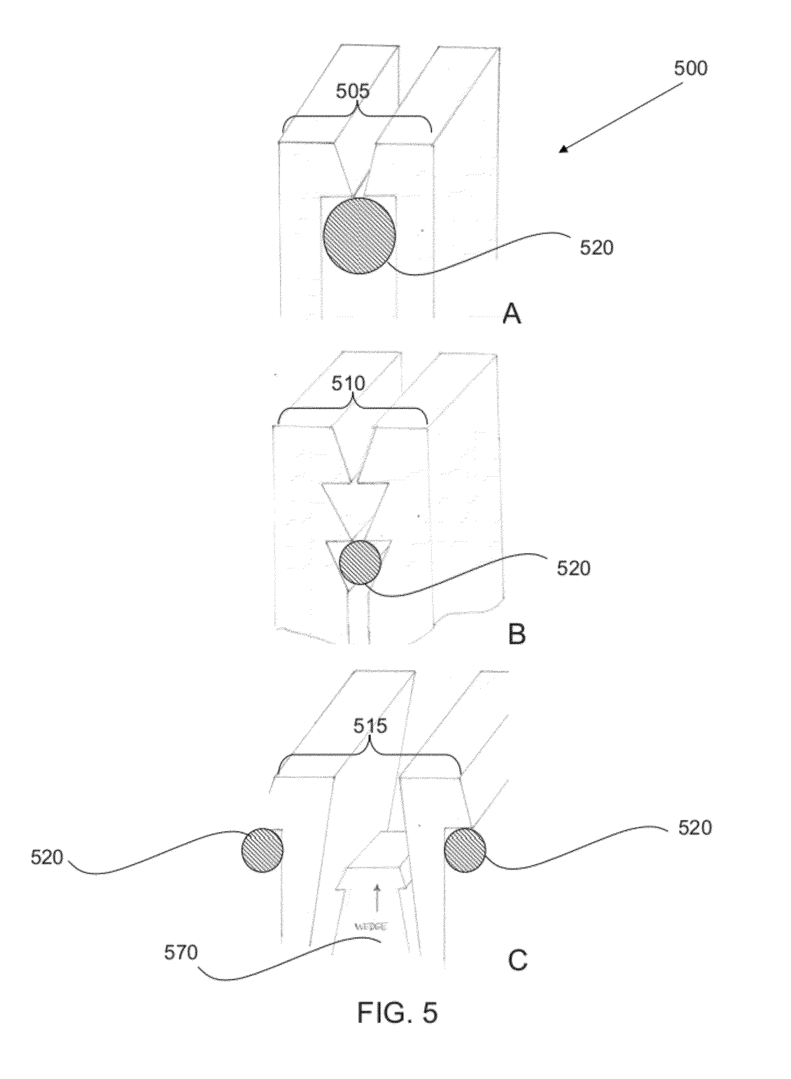

FIGS. 5A-5C illustrate clip fasteners for attaching a utility panel to a fence fabric, according to some embodiments. Clip fastener 505 is a single position fastener for clipping the utility panel to fence fabric 520. Clip fastener 510 is a ratcheting-type mechanism, wherein the clip can adjust for a variety of fence fabric configurations. Clip fastener 515 is a wedge-type clip, wherein the wedge 570 and can be viewed generally in the same light as the mechanical translational wedges otherwise taught in the embodiments provided herein.

It should be appreciated that the clip fasteners can be present as a single clip or a plurality of clips, and the clip fasteners can be used in combination with any other faster known to one of skill, including the fastening means taught herein.

### Example 6

### Variability in Chain Link Fences

One of skill will appreciate the need for a utility panel that is adjustable and can accommodate a wide variety of fence fabric configurations. In some embodiments, the fasteners taught herein can be adjustable on the vertical base panel as well, in order to further facilitate providing a utility panel configuration for the variable fence fabric geometries and configurations.

The following table provides a teaching of the variability that can be expected across-the-board, at least, for a variety of chain-link fence types:

Chain Link Fabric Mesh and Wire Gauge
Configurations with Wire Break Load

| | Mesh Size | | | | |
|---|---|---|---|---|---|
| | 6 gauge | 9 gauge | 11 gauge | 11½ gauge | *12 gauge |
| | Inches (mm) | | | | |
| | 0.192 in. | 0.148 in. | 0.120 in. | 0.113 in. | 0.105 in. |
| | (4.88 mm) | (3.76 mm) | (3.05 mm) | (2.87 mm) | (2.67 mm) |
| 2 | S, HI | HI, I, C, R | C, R | R | R |
| (50.8) | | | | | |
| 1¾ | S, HI | HI, I, T | T | R | R |
| (44.5) | | | | | |
| 1¼ | NM | S, HI | I, C, R, P | C, R, P | R, P |
| (31.8) | | | | | |
| 1 | NM | S, HI, I | HI, I, C | I, C, R | R |
| (25.4) | | | | | |
| ⅝ | NM | HS | HS, S | S | S, HI |
| (15.8) | | | | | |
| ½ | NM | HS | HS, S | S | S, HI |
| (12.7) | | | | | |
| ⅜ | NM | NM | HS, S | HS, S | S, HI |
| (9.5) | | | | | |
| Wire | 2170 | 1290 | 850 | 750 | 650 |
| Breakload | | | | | |
| lbf | | | | | |
| Wire | 9650 | 5740 | 3780 | 3340 | 2890 |
| Breakload | | | | | |
| N | | | | | |

[2″ 9 gauge is the most specified mesh for commercial and industrial applications]
General Applications:
C = Commercial
I = Industrial
HI = Heavy Industrial
R = Residential
T = Tennis court
S = Security
HS = High Security
NM = Not Manufactured
P = residential swimming pool fabric
Polymer coated wire gauge is designated by the steel wire core gauge not the coated finish
*12 gauge core PVC coated fabric
Chain link fabric height: The standard heights produced are 3 feet up to 12 feet. Some fabrics can be special ordered in heights up to 20 feet.
Chain link fabric selvage (top and bottom edge finish): Knuckled selvage refers to bending the two adjacent pairs of wire back into a tight loop. Twist selvage refers to twisting the adjacent pairs of wire into a close helix of the equivalent to three full twists. The twist selvage has two sharp points for the purpose of enhancing security, for security applications the twist selvage can be specified for the top and bottom selvage. For consumer safety consideration, chain link fabric having 2 inch mesh in heights less than 72 inches and fabric having a mesh size less than 2 inches are manufactured having a knuckled finish at the top and bottom, “K&K”. Chain link fabric having 2 inch mesh in heights 72 inches and greater is manufactured having a knuckle finish at one selvage and a twist selvage at the other, “K&T”. SAFETY ALERT: Specify K&K selvage for 2 inch mesh in heights 72 inches and greater for play area, parks, play fields, ball fields, pools etc.
See Master Halco, Inc., Irving, TX 75038

One of skill reading the teachings will appreciate that the concepts can extend into additional embodiments that go well-beyond a literal reading of the claims, the inventions recited by the claims, and the terms recited in the claims.

We claim:

1. A portable, utility panel for adding a utility to a fencing material, comprising:
a vertical base panel including a front surface having a utility and a back surface, the back surface positioned parallel, or substantially parallel, to a fencing material during a use of the utility panel; and,
tool-free fasteners attached to the vertical base panel for releasably connecting the vertical base panel to the fencing material in a fixed, or substantially fixed, position relative to an x, y, and z-direction;
wherein,
the x and y directions are on a plane formed by the vertical base panel and are parallel, or substantially parallel, to a plane formed by the fencing material;
the z direction is normal, or substantially normal, to the plane formed by the fencing material; and
there is no, or substantially no, translational movement of the vertical base relative to the fencing material during the use of the utility panel, the translational movement including movement in the x and y directions.

2. The panel of claim 1, wherein the fencing material is a fencing fabric comprising chain-link fencing material.

3. The panel of claim 1, wherein the tool-free fasteners are positioned, or positionable, as a plurality of prongs configured to insert in an opening in the fencing fabric under tension to form a releasably connectable friction fitting between the fasteners and the fencing fabric.

4. The panel of claim 1, wherein the tool-free fasteners are positioned, or positionable, as a plurality prongs configured to insert in an opening in the fencing fabric under tension to form a releasably connectable friction fitting between the fasteners and the fencing fabric, the releasably connectable friction fitting including a hook on a prong in the plurality of prongs to inhibit movement of the vertical base panel in the z-direction.

5. The panel of claim 1, wherein the tool-free fasteners are positioned, or positionable, as a plurality prongs configured to insert in an opening in the fencing fabric under tension to form a releasably connectable friction fitting between the fasteners and the fencing fabric, the releasably connectable friction fitting including a ratcheting mechanism to inhibit movement in the z-direction.

6. The panel of claim 1, wherein the tool-free fasteners include a means for fastening the vertical base panel to a chain link fence.

7. A portable, coaching-utility panel for adding a coaching-utility to a fencing material, comprising:
a vertical base panel including a front surface having a coaching-utility and a back surface, the back surface positioned parallel, or substantially parallel, to a fencing material during a use of the coaching-utility panel; and,
tool-free fasteners attached to the vertical base panel for releasably connecting the vertical base panel to the fencing material in a fixed, or substantially fixed, position;
wherein, there is no, or substantially no, translational movement of the vertical base relative to the fencing material during the use of the coaching-utility panel, the translational movement including movement in the x and y directions relative to the plane of the fencing material.

8. The panel of claim 7, wherein the fencing material is a fencing fabric comprising chain-link fencing material.

9. The panel of claim 7, wherein the tool-free fasteners are positioned, or positionable, as a plurality of prongs configured to insert in an opening in the fencing fabric under tension to form a releasably connectable friction fitting between the fasteners and the fencing fabric.

10. The panel of claim 7, wherein the tool-free fasteners are positioned, or positionable, as a plurality prongs configured to insert in an opening in the fencing fabric under tension to form a releasably connectable friction fitting between the fasteners and the fencing fabric, the releasably connectable friction fitting including a hook on a prong in the plurality of prongs to inhibit movement of the vertical base panel in the z-direction.

11. The panel of claim 7, wherein the tool-free fasteners are positioned, or positionable, as a plurality prongs configured to insert in an opening in the fencing fabric under tension to form a releasably connectable friction fitting between the fasteners and the fencing fabric, the releasably connectable friction fitting including a ratcheting mechanism to inhibit movement in the z-direction.

12. The panel of claim 7, wherein the tool-free fasteners include a means for fastening the vertical base panel to a chain link fence.

13. The panel of claim 7, wherein the coaching utility includes a plurality of uses including (i) hangers for sporting equipment and (ii) a surface for displaying written materials.

14. A portable, gardening-utility panel for adding a gardening-utility to a fencing material, comprising:
a vertical base panel including a front surface having a gardening-utility and a back surface, the back surface positioned parallel, or substantially parallel, to a fencing material during a use of the gardening-utility panel; and,
tool-free fasteners attached to the vertical base panel for releasably connecting the vertical base panel to the fencing material in a fixed, or substantially fixed, position;
wherein, there is no, or substantially no, translational movement of the vertical base relative to the fencing material during the use of the gardening-utility panel, the translational movement including movement in the x and y directions relative to the plane of the fencing material.

15. The panel of claim 14, wherein the fencing material is a fencing fabric comprising chain-link fencing material.

16. The panel of claim 14, wherein the tool-free fasteners are positioned, or positionable, as a plurality of prongs configured to insert in an opening in the fencing fabric under tension to form a releasably connectable friction fitting between the fasteners and the fencing fabric.

17. The panel of claim 14, wherein the tool-free fasteners are positioned, or positionable, as a plurality prongs configured to insert in an opening in the fencing fabric under tension to form a releasably connectable friction fitting between the fasteners and the fencing fabric, the releasably connectable friction fitting including a hook on a prong in the plurality of prongs to inhibit movement of the vertical base panel in the z-direction.

18. The panel of claim 14, wherein the tool-free fasteners are positioned, or positionable, as a plurality prongs configured to insert in an opening in the fencing fabric under tension to form a releasably connectable friction fitting between the fasteners and the fencing fabric, the releasably connectable friction fitting including a ratcheting mechanism to inhibit movement in the z-direction.

19. The panel of claim 14, wherein the tool-free fasteners include a means for fastening the vertical base panel to a chain link fence.

20. The panel of claim 14, wherein the coaching utility includes a plurality of uses including (i) hangers for gardening equipment and (ii) a surface for displaying a plant.
